(19) United States
(12) Patent Application Publication
(10) Pub. No.: US 2009/0060171 A1
(43) Pub. Date: Mar. 5, 2009

(54) Letter Pattern on the Dial Key Buttons of a Mobile Telephone

(76) Inventors: Tatsushi Masuya, Saitama (JP); Masaharu Nishio, Osaka (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/131,727

(22) Filed: Jun. 2, 2008

(30) Foreign Application Priority Data
Aug. 29, 2007 (JP) 2007-006712
Nov. 13, 2007 (JP) 2007-008769

(51) Int. Cl. H04M 1/00

(52) U.S. Cl. 379/447

(57) ABSTRACT

A sticker includes a “number” and “letters” that are larger than the “number” on a dial key button of a mobile telephone, wherein the sticker is to be put on a part of a dial key button of a mobile telephone.

This application claims the priority of Japanese Utility Model No. 2007-006712, filed on Aug. 29, 2007, and the priority of Japanese Utility Model No. 2007-008769, filed on Nov. 13, 2007, the entire disclosures of which utility models are incorporated herein by reference.

### BACKGROUND OF THE INVENTION

1. Field of the Invention

This invention relates to a letter pattern on the dial key buttons of a mobile telephone.

2. Description of Related Art

The dial key buttons of a conventional mobile telephone have both “numbers” and “letters” (“Alphabets”), both of which are printed on the faces of the key buttons. The size of the “numbers” is greater than that of the “letters,” because the conventional mobile telephone is designed for a user to use the “numbers” to place a telephone call.

However, nowadays, most users dial a telephone number by selecting the telephone number from the telephone's directory, in which telephone numbers are stored. It is rare for a user to enter each digit of a telephone number to place a telephone call. Usually this happens only when a user is entering a telephone number into the directory of a mobile telephone.

In comparison, “letters” are used frequently when people write e-mails, or search a telephone number from a telephone's director with a name or a keyword.

However, because the “letters” are small on a conventional telephone, it is difficult to recognize the “letters” in the dark. In addition, since the “letters” are small, it is difficult for a presbyopic user to see the “letters” and may have to memorize the key buttons for the “letters.”

### SUMMARY OF THE INVENTION

To solve these problems, the present invention provides key boards, stickers, dial key buttons, which have “letters” (or “alphabets”) that are larger and in particular larger than the “numbers.”

An effect of the invention is that by using this invention, users of mobile telephones can reduce the number of mistakes in selecting key buttons and can use a mobile telephone more comfortably even if they are in a dark place or they are presbyopic.

### BRIEF DESCRIPTION OF THE DRAWINGS

FIG. 1 shows conventional mobile telephone dial key buttons that have “numbers” that are larger than the “letters.”

FIG. 2 shows mobile telephone dial key buttons of the present invention, which have “letters” that are larger than the “numbers.”

FIG. 3 shows a sticker (stickers) embodying the present invention, with a dial key pattern that has “letters” that are larger than the “numbers.”

FIG. 4 shows a sticker having a dial key pattern of the present invention, and several labels to put on the sticker.

FIG. 5 shows a cover having a dial key pattern of the present invention, which can be attached to the key buttons of a mobile telephone.

FIG. 6 shows a mobile telephone that have stickers having a dial key pattern of this invention which are printed and carved, filled out, or attached to a dial key part of the mobile phone.

FIG. 7 shows a sticker having a dial key pattern of this invention, wherein the sticker is not put on each individual dial key button but put on the whole dial part of a mobile telephone.

### DETAILED DESCRIPTION OF THE INVENTION

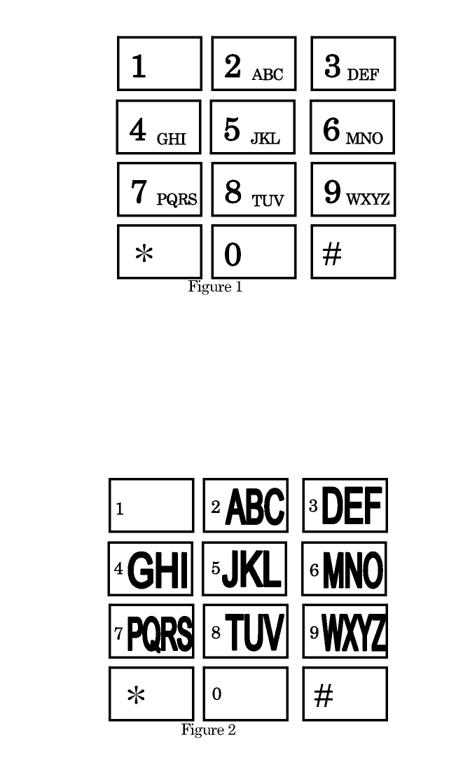

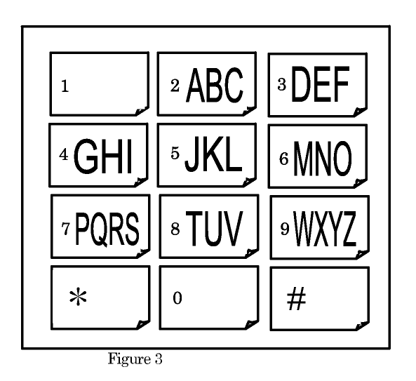

The best mode to carry out this invention. A mobile telephone user chooses her favorite pattern from FIG. 1 or FIG. 2. By doing so, she can easily push the dial key buttons based on her selection.

Methods of using the present invention are as follows:
1. putting stickers with large “letters” on dial key buttons of a mobile phone;
2. attaching a cover with large “letters” on dial key buttons of a mobile phone; or
3. printing, carving a sticker having a dial key pattern with large “letters,” filling it out, and/or attaching it on a dial key part when a mobile telephone is produced.

In case of a sticker (Above 1) or a cover (Above 2), there is the case that the kinds or places of labels excepting “numbers”, “letters”, “*”, and “#” are different based on the models of the mobile telephone. In such a case, stickers and covers are produced for every model.

Or labels which are prepared separately are put on the “letters” parts, or labels are handwritten and put on the “letters” parts. (See FIG. 4.)

In case of producing a dial key button like claim 3, as each mobile telephone is produced individually, the above problem is already solved.

When it is troublesome to put a sticker one by one on each dial key button, instead of the stickers which are divided for each button, a sticker which has the pattern of all buttons is put on a mobile telephone. (See FIG. 7.)

### Embodiment 1

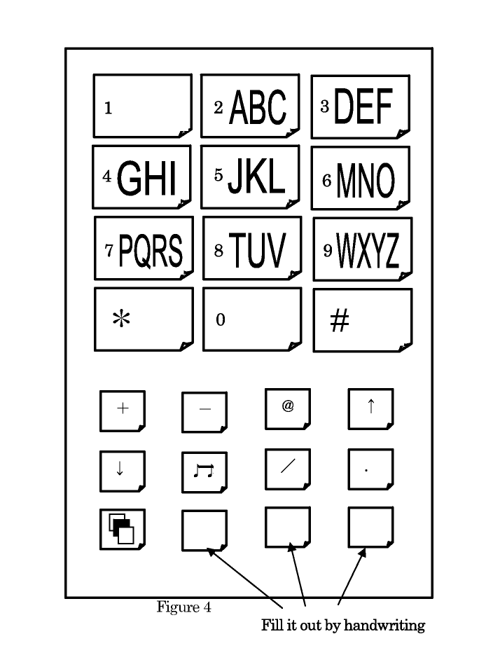

FIG. 3 is an example where a sticker having large “letters” is put on each dial key button.

### Embodiment 2

FIG. 4 is an example where a sticker having large “letters” is put on each dial key button, and labels are put on the “letters” parts.

### Embodiment 3

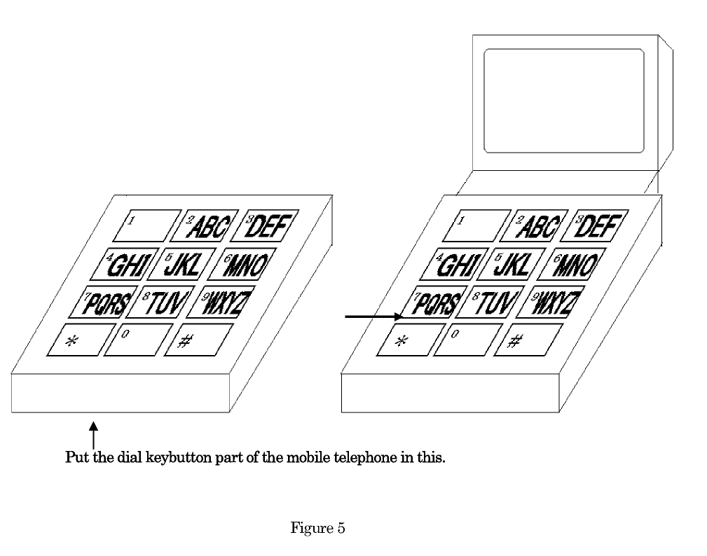

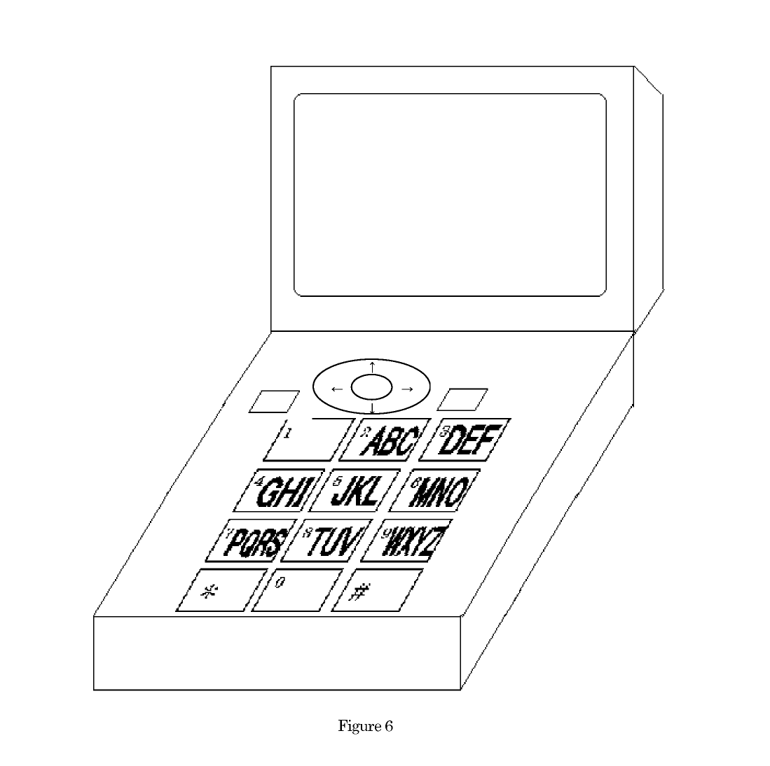

FIG. 5 is an example where a cover having large “letters” is attached to the dial key button part of a mobile telephone.

### Embodiment 4

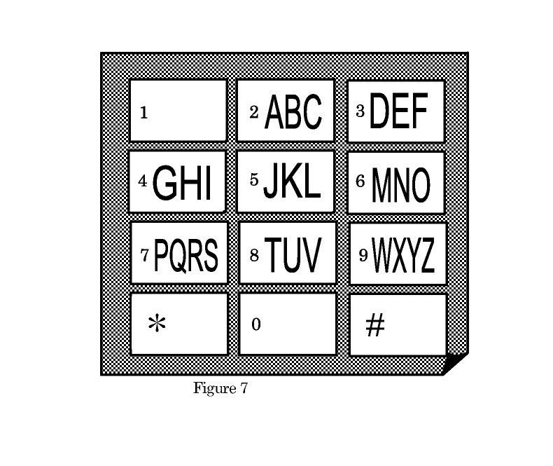

FIG. 6 is an example of a mobile telephone where large “letters” are printed on the dial key button part of the mobile phone.

1. A sticker comprising a “number” and “letters” that are larger than the “number” on a dial key button of a mobile telephone, wherein the sticker is to be put on a part of a dial key button of a mobile telephone.

2. A cover comprising a “number” and “letters” that are larger than the “number” on a dial key button of a mobile telephone, wherein the cover is to be attached to a part of a dial key button of a mobile telephone.

3. A dial key button of a mobile telephone comprising “letters” that are printed on and carved from a sticker, are filled out, or are attached the dial key button, wherein the “letters” of the dial key button are greater than a “number” of the dial key button.
